(19) United States
(12) Patent Application Publication
(10) Pub. No.: US 2020/0157293 A1
(43) Pub. Date: May 21, 2020

(54) Pultruded Impregnated Fibers and Uses Therefor

(71) Applicant: Zephyros, Inc., Romeo, MI (US)

(72) Inventor: Craig Chmielewski, Romeo, MI (US)

(21) Appl. No.: 16/610,730

(22) PCT Filed: May 4, 2018
(86) PCT No.: PCT/US2018/031022

§ 371 Date: Nov. 4, 2019

Related U.S. Application Data
(60) Provisional application No. 62/501,339, filed on May 4, 2017.

(51) Int. Cl. C08J 5/04; B29C 70/52; C08J 5/24; B29K 101/12; B29K 309/08

(52) U.S. Cl. CPC C08J 5/048; C08J 5/043; B29K 2309/08; C08J 5/24; B29K 2101/12; B29C 70/521

(57) ABSTRACT

A pultruded article, comprising a fiber phase in the pultruded article and polymeric matrix in the pultruded article, the polymeric matrix impregnated within the fiber phase prior to pultruding the pultruded article; wherein the pultruded article forms at least a portion of a carrier adapted for use as a baffle, a structural reinforcement of both.

### TECHNICAL FIELD

The present invention relates generally to fibers impregnated with a thermoplastic material and the use of such fibers for forming pultruded articles.

### BACKGROUND

There is an ongoing effort in many industries to lighten the weight of articles. In many instances, this is achieved by the selection of materials that have a lower density, thinner section thicknesses or both, as compared with prior materials or structures. As a result, there is a potential for the weakening of structures, and the consequent need for stiffening or other structural reinforcement.

As a result of these light-weighting efforts, polymeric materials are commonly used. These polymeric materials are generally molded, extruded, or pultruded in an effort to maintain low weight and high strength. However, a variety of significant challenges are encountered when attempting to pultrude a thermoplastic with a continuous fiber component. Typically thermoplastics have relatively high viscosity in the melt state which makes impregnating fiber bundles and wetting individual fiber filaments very difficult. Further, during pultrusion, a resin may be introduced as a blend of unreacted reactants or as separate multicomponent streams which react when combined near the entrance of the pultrusion process. These pre-reacted feed streams typically have very low viscosity and thus facilitate the impregnation and wetting of the continuous fiber bundles. This wetting process takes place inside the pultrusion die and, once complete, then has to chemically react to produce either a high molecular weight thermoplastic or crosslinked resin. All of this has to happen within the pultrusion die. The rate of this reaction has implications on die length and leads to residence time restrictions on processing rate. Lastly, most pultrusion processes produce articles for use in low temperature applications, requiring the use of thermoset resins (e.g. polyester, vinyl ester, polyurethane and epoxy) whose glass transition temperatures (Tg) are less than 200° C., or thermoplastics whose Tg or melt temperatures (Tm) are below 200° C.

It would thus be desirable to form lightweight pultruded articles with both fiber and thermoplastic components where wetting of the fibers need not occur in the die, where chemical reactions need not occur in the die and where the resulting articles can be utilized for high temperature applications (e.g., applications where temperatures exceed 200° C.).

### SUMMARY OF THE INVENTION

One or more of the above needs are met by the present teachings which contemplate improved structures and methods that can be employed advantageously for forming pultruded articles including a fiber component and thermoplastic component.

The teachings herein overcome the challenges set forth above by utilizing continuous fiber tows that are already pre-impregnated with a thermoplastic resin. As a result, the wetting process has already been completed (or substantially completed). Further, the use of such pre-impregnated fibers requires no substantial additional chemical reactions within the pultrusion die. Therefore there are no restrictions to the processing rate as the result of necessary chemical reactions. Furthermore, because the fibers are pre-impregnated with the resin, the resin can be chosen to have high temperature properties—such as a Tg or Tm above 200° C. In this way, the articles produced by this process can have either Tg or Tm higher than 200° C., and thus have useful high temperature exposure or use temperatures that are beneficial in many applications.

The teachings herein provide for a pultruded article, comprising a fiber phase in the pultruded article and a thermoplastic phase in the pultruded article, the thermoplastic phase impregnated within the fiber phase prior to pultruding the pultruded article. The pultruded article may be used to form at least a portion of a carrier adapted for use as a baffle, a structural reinforcement of both. The fiber phase may comprises glass fibers. The thermoplastic phase has a glass transition temperature (T_{g}) and/or melt temperature (Tₘ) greater than 150° C., or even greater than 200° C. The thermoplastic phase may comprise one or more of polyamide (PA, such as Nylon 6 and Nylon 66), polypropylene (PP), polyphenylene sulfide (PPS), polybutylene terephthalate (PBT), polyetheretherketone (PEEK), polyethylene terephthalate (PET), polycarbonate, polyethylene, polystyrene, polyvinyl chloride, or any combination thereof. The fiber phase may include a plurality of fibers having a length of at least about 1 mm.

The teachings herein further provide for pultruded article, comprising a plurality of comingled fibers including a glass fiber and a thermoplastic fiber, wherein the pultruded article forms at least a portion of a carrier adapted for use as a baffle, a structural reinforcement of both.

The teachings herein are also directed to use of the articles described herein as an insert of a carrier of a baffle, a structural reinforcement, or both, for a transportation vehicle. Also disclosed are uses of the articles described herein as part of a carrier of a baffle, a structural reinforcement, or both, for an automotive vehicle, wherein the carrier supports an activatable polymeric material adapted to foam upon being subjected to a predetermined activation condition and to adhere to a portion of a transportation vehicle.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This teachings herein provide for a process for producing axi-symmetric, unidirectional continuous fiber composites very quickly. It is predicated on the availability of pre-impregnated fiber tows. A plurality of these fiber tows may be drawn through a heated die to a temperature where the resin contained within these tows softens and/or melts so that, combined with the design and shape of the die, they are consolidated to the desired shape and fiber volume fraction.

Examples of pre-impregnated fiber bundles are commercially available from Fibrtec Inc. (Atlanta, Tex.). The fiber bundles may include one or any combination of carbon, glass, aramid and basalt fibers, impregnated with polyamide (PA, such as Nylon 6 and Nylon 66), polypropylene (PP), polyphenylene sulfide (PPS), polybutylene terephthalate (PBT), polyetheretherketone (PEEK), polyethylene terephthalate (PET), polycarbonate, polyethylene, polystyrene, polyvinyl chloride, or any combination thereof. Fiber volume fractions range from about 40 to about 60 wt. %.

Another example of fiber/resin blends for use in pultruding the articles described herein is commingled fiber resin products, such as those manufactured and sold by Concordia Manufacturing, LLC. (Coventry, R.I.). Such comingled fibers blend unsized continuous filament carbon fiber with unsized continuous filament thermoplastic fibers to produce a yarn.

The teachings herein provide for a process for softening and melting pre-impregnated or comingled thermoplastic/reinforcing fiber bundles, and then consolidating these fibers into a desired shape. As a result, this precludes the need for the added complexity of simultaneously impregnating, reacting and consolidating a fiber-resin system. Removing this complexity allows for high production rates that are limited only by the time needed to melt and consolidate the fiber-resin system. This in turn allows for much higher throughput rates than conventional pultrusion processes, and makes available a much larger number of possible resin/fiber combinations that are possible to process.

As an additional benefit to the teachings herein, the viscosity of thermoplastics in the melt state is typically too high to adequately impregnate large amounts of fibers encountered in a typical pultrusion process. Thus, the pre-impregnated fibers limit the need for such a step. In addition, the chemical reaction requirements of time, temperature and pressure needed to produce most thermoplastics do not align well with the narrow time, temperature and pressure processing window afforded by standard pultrusion processes to facilitate the in-situ polymerization of these materials. As a result, the teachings herein simplify the pultrusion process and provide a means for producing a wide variety of thermoplastic/reinforcing combinations. Especially relevant for the automotive industry are pultruded continuous fiber pultruded articles based on high temperature (>175° C. Tg or Tm) thermoplastics that could be useful in high temperature environments (e.g. under-the-hood) or survive assembly line ovens (e.g. e-coat or paint oven baking) without substantial forfeit of properties or dimension.

The teachings herein further describe operations of cooling the pultruded article immediately following its exit from the pultruded die, and possibly post baking, post shaping, forming attachments, adhesive addition or any other post-pultrusion processes.

The teachings herein relate to pultruded articles which may be composite articles. The pultruded article may be in a form suitable for use as part of a baffle and/or structural reinforcement for a transportation vehicle. The pultruded article may be in a form suitable for use as a panel structure. The pultruded article may be in a form suitable for use as a building construction material, as a furniture material, as a sporting good material (e.g., for skis, snowboards, bicycles, bats, tennis rackets or the like) or as protective gear material (e.g., for police shields, armored vehicle panels, or the like). The fibrous pultruded materials of any pultruded article herein may include a single phase or may include at least two phases. For example, it may include a distributed phase and a matrix phase within which the distributed phase is distributed. The distributed phase in the pultruded article may include a plurality of elongated (e.g., in a ratio of at least 2:1 as between a major and minor dimension of the form) segmented forms selected from fibers, platelets, flakes, whiskers, or any combination thereof. For fibers employed herein, the fibers may be employed in the distributed phase is in the form of a random distribution, a weave, a non-woven mat, a plurality of generally axially aligned fibers (e.g., a tow), a plurality of axially intertwined fibers (e.g., a yarn) or any combination thereof. A plurality of individual fibers may thus be in a generally ordered relationship (e.g., according to a predetermined pattern) relative to each other.

The ratio by weight of thermoplastic matrix to the fiber phase may be range from about 1:10 to about 100:1 (e.g., it may range from about 1:5 to about 10:1, about 1:3 to about 5:1, about 1:2 to about 2:1).

The fibrous material, which may be formed as a distributed phase, may include an organic material, an inorganic material or a combination of each. The material may be a naturally occurring material (e.g., a rubber, a cellulose, sisal, jute, hemp, or some other naturally occurring material). It may be a synthetic material (e.g., a polymer (which may be a homopolymer, a copolymer, a terpolymer, a blend, or any combination thereof)). It may be a carbon derived material (e.g., carbon fiber, graphite, graphene, or otherwise). The distributed phase may thus include fibers selected from (organic or inorganic) mineral fibers (e.g., glass fibers, such as E-glass fibers, S-glass, B-glass or otherwise), polymeric fibers (e.g., an aramid fiber, a cellulose fiber, or otherwise), carbon fibers, metal fibers, natural fibers (e.g., derived from an agricultural source), or any combination thereof. The plurality of elongated fibers may be oriented generally parallel to each other. They may be braided. They may be twisted. Collections of fibers may be woven and/or nonwoven.

The fibrous material may include a plurality of fibers having a length of at least about 1 cm, 3 cm or even 5 cm or longer. Fibers may have an average diameter of about 1 to about 50 microns (e.g., about 5 to about 25 microns). The fibers may have a suitable sizing coating thereon. The fibers may be present in each layer, or in the fibrous insert generally, in an amount of at least about 20%, 30%, 40% or even 50% by weight. The fibers may be present in each layer, or in the fibrous insert generally, in an amount below about 90%, 80%, or even about 70%, by weight. By way of example, the fibers may be present in each layer, or in the fibrous insert, in an amount of about 50% to about 70% by weight. Fiber contents by weight may be determined in accordance with ASTM D2584-11. The fibers may comprise the reformable thermoplastic polymeric material as described herein.

The fibers may be present in an amount, a distribution, or both for reinforcing the pultruded article by the realization of an increase of one or more mechanical properties selected from ultimate tensile strength, elongation, flexural modulus, compression modulus, or otherwise, as compared with the corresponding property of the polymer matrix material alone.

As can be appreciated, a variety of suitable pultruded profiles are possible as a result of the teachings. The profiles may include a longitudinal axis. The pultruded profiles may be symmetric or asymmetric relative to the longitudinal axis. The pultruded profiles may include one or more longitudinally oriented ribs. The pultruded profiles may include one or more transversely extending flanges. The pultruded profiles may include both flat portions and curved portions. The pultruded profiles may have one or more outer surfaces. The pultruded profile may have one or more inner surfaces.

The teachings also envision a possible manufacturing system that may be employed for an extrusion operation in accordance with the present teachings. Raw material for forming a base polymeric material body are fed into a hopper associated with an extruder. The extruder may have a die through which the raw material is passed to form a shaped body profile (e.g., an extruded profile). The shaped body profile may be cooled (e.g., by a vacuum cooler) to a desired temperature (e.g., below the softening point of the material, so that it retains its shaped state). A feed system may feed a fibrous material (e.g., by way of rollers) to a suitable device for applying a matrix material for defining a pultruded fibrous material (e.g., a roll coater). At such device, the material for forming a polymeric matrix is contacted with the fibrous material. A suitable device for defining a shape of the fibrous pultruded material may be employed, such as a forming roller, a heated press, or another suitable extrusion and/or pultrusion type shaping device). The forming roller or other suitable device may also serve to help join the fibrous pultruded material with the shaped base body profile.

The resulting overall pultruded part may be cooled (e.g., by a cooling tank). Optionally, if to be employed for use as a carrier for a baffling and/or structural reinforcement application, the resulting overall pultruded article may be advanced by a conveyor device (e.g., a pulling or pushing device). An activatable material (e.g., a polymeric heat activatable sealant, acoustic foamable material, and/or structural reinforcement material) may be applied to the pultruded by an extruder (e.g., a cross head extruder). Thereafter, the resulting article (with or without the activatable material on it) may be cut by a suitable cutting device (e.g., a traveling cut-off saw). By way of illustration, without limitation, the raw material may be a glass filled Nylon® heated to about 260° C. Upon exiting the cooler, the temperature may be about 150 to about 175° C. The fibers may be glass fibers. Upon exiting the cooling tank the pultruded may be at a temperature of about 120° C. At the time of passing the extruder, the temperature may be about 90-95° C. The cross-head extruder may extrude one or more masses of a heat activatable epoxy-based structural foam, such as the L-55xx series of materials, available from L&L Products, Inc. See, e.g., U.S. Pat. No. 7,892,396, incorporated by reference for all purposes (an illustrative composition is shown therein at Table I). The heat activatable material may be activatable to expand by foaming, and adhere to an adjoining surface (e.g., a wall defining a part of a vehicle, such as a wall defining a vehicle cavity). The activation may occur upon exposure to the heat of a paint bake oven or induction heating device, following an electrocoating deposition step. The resulting activated material may be expanded to at least about 50%, 100%, 200%, 400%, 600%, or even 1000% of its original volume. The resulting activated material may be expanded from its original volume, but in an amount that is below about 2500%, 2000% or even below about 1500% of its original volume.

Materials for a carrier body herein may be a polyamide, a polyolefin (e.g., polyethylene, polypropylene, or otherwise), a polycarbonate, a polyester (e.g., polyethylene terephthalate), an epoxy based material, a thermoplastic polyurethane, or any combination thereof. It may be preferred to employ a polyamide (e.g., polyamide 6, polyamide 6,6, polyamide 9, polyamide 10, polyamide 12 or the like). The materials of a carrier body and any overlay and/or insert may be generally compatible with each other in that they are capable of forming a mechanical or other physical interconnection (e.g., a microscopic interconnection) between them, they are capable of forming a chemical bond between them, or both. For example, the first and second materials may be such that they fuse together (e.g., in the absence of any adhesive) when heated above their melting point and/or their softening point. The carriers may also be overmolded with a secondary material, such secondary material may be a polymeric material such as a polyolefin, a polyamide, a polyester, a polyurethane, a polysulfone, or the like, or an expandable polymer (e.g., a structural foam or an acoustic foam).

One or more structural features may be incorporated into the pultruded article via selective heating, which may be conductive heating. In accordance with the present teachings there is envisioned that one or more assemblies may be made by selectively heating a portion of a structure having a wall with a thickness to elevate at least a portion of the thickness of the wall to a temperature above the glass transition temperature of a polymer (e.g., a polyamide as taught herein, which may be reinforced as described herein, such as with a fiber or other phase) that forms the wall. While the at least a portion of the thickness of the wall is above the glass transition temperature of the polymer that forms the wall, an article is contacted with the structure at least partially within the heated region, optionally under pressure. Thereafter, upon heat leaving the heated region, the polymer that forms the wall cools so that resulting polymer in contact with the article is cooled below the glass transition temperature. An adhesive bond thereby results, with the article remaining attached to the structure by way of the bond. The above method may be employed to form an adhesive bond either with or without an additional applied adhesive. That is, it may be possible that the material of the structure, when heated above its T_{g}, and then cooled below it, will be capable of forming an adhesive bond directly with the contacted article. Moreover, the tenacity of the bond may be sufficient so as to obviate the need for any fastener for securing the article to the structure. One option for achieving a bonded assembly in accordance with the above may be to employ an adhesive layer, wherein the adhesive layer (e.g., having a thickness below about 5 mm, 4 mm, or 3 mm, and above about 0.05, 0.1 or about 0.5 mm) is made of a reformable resin material as described herein.

The structure may be any of a number of suitable forms. For example, it may be an elongated beam. It may have a length and may be solid along all or part of the length. It may have a length and be hollow along all or part of the length. The structure may have a wall thickness, measured from a first exposed surface to a generally opposing exposed surface. The wall thickness may be at least about 0.5 mm, about 1 mm, about 2 mm, about 5 mm, about 10 mm, or about 20 mm. The wall thickness may be below about 100 mm, below about 80 mm, below about 60 mm, or below about 40 mm.

The structure may have a predetermined shape. The shape may include one or more elongated portions. The shape may include one or more hollow portions. The shape may include one or more walls that define at least one cavity. The structure may include a plurality of portions each having a different shape. The structure may be configured to define a fascia, which optionally may be supported by an underlying structure. The structure may be configured to define a support that underlies a fascia. The structure may have a panel configuration, e.g., a configuration that resembles a transportation vehicle (e.g., an automotive vehicle) exterior body or interior trim panel.

The structure may be configured to receive and support one or a plurality of articles (e.g., transportation vehicle components), such as for forming a module. By way of illustration the one or more articles may be selected from a bracket, a hinge, a latch, a plate, a hook, a fastener (e.g., a nut, a bolt or otherwise), a motor, a component housing, a wire harness, a drainage tube, a speaker, or otherwise.

Heat may be applied in any suitable way. One approach may be to employ localized heating. For example, it is possible to employ induction heating for selectively heating at least a portion of the above-described structure. To illustrate, it is possible that the structure will be made with a polymer (e.g., a polyamide as taught herein, which may be reinforced as described herein, such as with a fiber or other phase), and will have a wall thickness. A metallic item (which may be a component desired to be attached to the structure) may be brought into proximity (which may or may not be in contacting relation) with the structure at the desired location of attachment. An induction heating device may be brought into proximity with the metallic item for heating the metallic item, which in turn will heat the structure in the affected location when power is supplied to the induction heating device. Other heating devices may be employed as well for achieving localized heating.

It is possible that time that elapses from the time the structure is initially heated until when an article becomes attached to it by the above steps may be relative short. For example, the operation may take less than about 1 minute, less than about 30 seconds, or less than about 15 seconds. It may take as low as about 1 second, about 3 seconds, or about 5 seconds.

By way of example, the pultruded article may be positioned within a cavity of a transportation vehicle (e.g., an automotive vehicle) prior to coating the vehicle. The activatable material may be activated when subjected to heat during paint shop baking operations. In applications where the activatable material is a heat activated, thermally expanding material, an important consideration involved with the selection and formulation of the material comprising the activatable material is the temperature at which a material reaction or expansion, and possibly curing, will take place. For instance, in most applications, it is undesirable for the material to be reactive at room temperature or otherwise at the ambient temperature in a production line environment. More typically, the activatable material becomes reactive at higher processing temperatures, such as those encountered in an automobile assembly plant, when the material is processed along with the automobile components at elevated temperatures or at higher applied energy levels, e.g., during paint or e-coat curing or baking steps. While temperatures encountered in an automobile assembly operation may be in the range of about 140° C. to about 220° C., (e.g., about 148.89° C. to about 204.44° C. (about 300° F. to 400° F.)), body and paint shop applications are commonly about 93.33° C. (about 200° F.) or slightly higher. Following activation of the activatable material, the material will typically cure. Thus, it may be possible that the activatable material may be heated, it may then expand, and may thereafter cure to form a resulting foamed material.

Pultruded articles made in accordance with the present teachings may have a wall having a first surface and a generally opposing second surface. The wall may have a thickness ranging from about 0.2 to about 6 mm (e.g., about 1.5 to about 4 mm).

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A pultruded article, comprising:
a. a fiber phase in the pultruded article; and
b. a thermoplastic phase in the pultruded article, the thermoplastic phase impregnated within the fiber phase prior to pultruding the pultruded article;
wherein the pultruded article forms at least a portion of a carrier adapted for use as a baffle, a structural reinforcement of both.

2. The pultruded article of claim 1, wherein the fiber phase comprises glass fibers.

3. The pultruded article of claim 1, wherein the thermoplastic phase has a glass transition temperature (T_{g}) and/or melt temperature (Tₘ) greater than 150° C., or even greater than 200° C.

4. The pultruded article of claim 1, wherein the fiber phase includes a plurality of fibers having a length of at least about 1 mm.

5. The pultruded article of claim 2, wherein the thermoplastic phase comprises one or more of polyamide (PA, such as Nylon 6 and Nylon 66), polypropylene (PP), polyphenylene sulfide (PPS), polybutylene terephthalate (PBT), polyetheretherketone (PEEK) and polyethylene terephthalate (PET), polycarbonate, polyethylene, polystyrene, polyvinyl chloride, or any combination thereof.

6. The pultruded article of claim 4, including an activatable material located onto at least a portion of the article.

7. The pultruded article of claim 2, wherein the ratio by weight of thermoplastic phase to the fiber phase may be range from about 1:10 to about 100:1 (e.g., it may range from about 1:5 to about 10:1, about 1:3 to about 5:1, about 1:2 to about 2:1).

8. The pultruded article of claim 4, wherein the fiber phase in an amount below about 90%, 80%, or even about 70%, by weight.

9. The pultruded article of claim 1, wherein the article includes a longitudinal axis.

10. The pultruded article of claim 1, wherein the article includes a metallic component.

11. The pultruded article of claim 7, wherein the thermoplastic phase when heated above its T_{g}, and then cooled below it, is adapted to form an adhesive bond directly with an adjacent surface.

12. The pultruded article of claim 1, wherein the fiber phase and the thermoplastic phase are compatible with each other so that they form a mechanical or other physical interconnection (e.g., a microscopic interconnection) between them, they form a chemical bond between them, or both.

13. The pultruded article of claim 1, including an adhesive layer, having a thickness below about 5 mm and above about 0.05 mm.

14. The pultruded article of claim 1, wherein the article has a wall thickness may be at least about 0.5 mm and below about 100 mm.

15. The pultruded article of claim 1, wherein the fiber phase is a woven fiber, a non-woven fiber or some combination thereof.

16. The pultruded article of claim 4, wherein the fiber phase comprises comingled fibers including continuous filaments of carbon fiber with continuous filaments of thermoplastic fibers to produce a yarn.

17-19. (canceled)

20. A method for forming the article of claim 1, including providing localized heating to a portion of the article.

21. The pultruded article of claim 1, wherein the fiber phase comprises glass fibers and thermoplastic fibers that are comingled.

22. The pultruded article of claim 21, wherein the article includes an adhesive located onto at least a portion of the article.

23. The pultruded article of claim 21, wherein the article includes a longitudinal axis and the comingled fibers extend the full length of the article along its longitudinal axis.
